(19) United States
(12) Patent Application Publication
(10) Pub. No.: US 2016/0070403 A1
(43) Pub. Date: Mar. 10, 2016

(54) WEARABLE PODS AND DEVICES INCLUDING METALIZED INTERFACES

(71) Applicants: Sumit Sharma, San Francisco, CA (US); Chris Singleton, San Francisco, CA (US); Piyush Savalia, San Francisco, CA (US); Prasad Panchalan, San Francisco, CA (US); Sheila Nabanja, San Francisco, CA (US); Iiyas Mohammad, San Francisco, CA (US)

(72) Inventors: Sumit Sharma, San Francisco, CA (US); Chris Singleton, San Francisco, CA (US); Piyush Savalia, San Francisco, CA (US); Prasad Panchalan, San Francisco, CA (US); Sheila Nabanja, San Francisco, CA (US); Iiyas Mohammad, San Francisco, CA (US)

(73) Assignee: AliphCom, San Francisco, CA (US)

(21) Appl. No.: 14/480,446

(22) Filed: Sep. 8, 2014

(51) Int. Cl. G06F 3/041; G06F 3/01; G06F 1/16; G06F 3/044

(52) U.S. Cl. CPC G06F 3/0416; G06F 3/044; G06F 3/015; G06F 1/163; G06F 1/1692

(57) ABSTRACT

Embodiments relate generally to electrical and electronic hardware, computer software, wired and wireless network communications, and computing devices. More specifically, a wearable pod and/or device and processes to form the same facilitate implementation of a touch-sensitive interface in association with a predominately opaque surface. According to an embodiment, formation of a wearable pod includes detecting a capacitance value at a pod cover portion, determining a mode of operation based on a capacitance value, receiving subsets of sensor data, and selecting a subset of sensor data based on a mode of operation. The method can include determining values of at least one physiological signal and identifying a subset of light sources to emit light through an arrangement of micro-perforations constituting symbols indicative of the values of the physiological signal.

### FIELD

Embodiments relate generally to electrical and electronic hardware, computer software, wired and wireless network communications, and computing devices. More specifically, a wearable pod and/or device and processes to form the same facilitate implementation of a touch-sensitive interface in association with a predominately opaque surface.

### BACKGROUND

Wearable devices have leveraged increased sensor and computing capabilities that can be provided in reduced personal and/or portable form factors, and an increasing number of applications (i.e., computer and Internet software or programs) for different uses, consumers (i.e., users) have given rise to large amounts of personal data that can be analyzed on an individual basis or an aggregated basis (e.g., anonymized groupings of samples describing user activity, state, and condition).

Presently, development and design of many wearable devices, such as so-called “smart watches,” are including glass-based touchscreens to enable users to interact with glass (or transparent plastic) to provide user input or receive visual information. An example of a glass-based touch screen includes CORNING® GORILLA® GLASS, or those formed using OLED or other like technology. Developers of wearable devices using such touchscreens continue to face challenges, not only technically but in user experience design. For example, relatively large glass-based touchscreens may be perceived to be to “bulky” or “unwieldy” for some consumers, whereas miniaturized glass-based screens may fail to provide sufficient information to a user. Moreover, some conventional touchscreens are susceptible to the environments in which users typically expect reliable operation. While conventional wearable devices typically are functional, such devices have sub-optimal properties that consumers view less favorably.

Thus, what is needed is a solution for facilitating the use and manufacture of wearable devices without the limitations of conventional devices or techniques.

### BRIEF DESCRIPTION OF THE DRAWINGS

Various embodiments or examples (“examples”) of the invention are disclosed in the following detailed description and the accompanying drawings:

FIG. 1 is an exploded view of an example of a wearable pod having, for example, an opaque surface, according to some embodiments;

FIG. 2 is a diagram depicting a touch-sensitive I/O controller, according to some embodiments;

FIGS. 3A to 3D are diagrams depicting various aspects of an interface of a wearable pod, according to some examples;

FIGS. 4A to 4D depict examples of micro-perforations, according to some examples;

FIGS. 5A to 5D are diagrams depicting another example of a display portion for a wearable pod, according to some embodiments;

FIG. 6 is an example of a flow to form a wearable pod, according to some embodiments;

FIG. 7 illustrates an exemplary computing platform disposed in a wearable pod configured to facilitate a touch-sensitive interface in an opaque or predominately opaque surface in accordance with various embodiments;

FIG. 8 is an exploded perspective view of an example of a wearable pod having, for example, a metal surface, according to some embodiments;

FIG. 9 is an exploded front view of an example of a wearable pod having, for example, a metal surface, according to some embodiments;

FIGS. 10A to 10B are respective exploded perspective and exploded front views of a wearable pod including anchor portions, according to some embodiments;

FIG. 10C is a bottom perspective view of a pod cover implementing a sealant during assembly, according to some embodiments;

FIG. 10D is a diagram depicting a perspective front view of a wearable pod being assembled as part of a wearable device, according to some embodiments;

FIGS. 11A and 11B are diagrams depicting a cross-section of a portion of an isolation belt, according to some examples;

FIG. 12 depicts an example of a flow to form a touch-sensitive pod cover for a wearable pod, according to some examples; and

FIG. 13 depicts an example of a flow for a touch-sensitive wearable pod, according to some embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

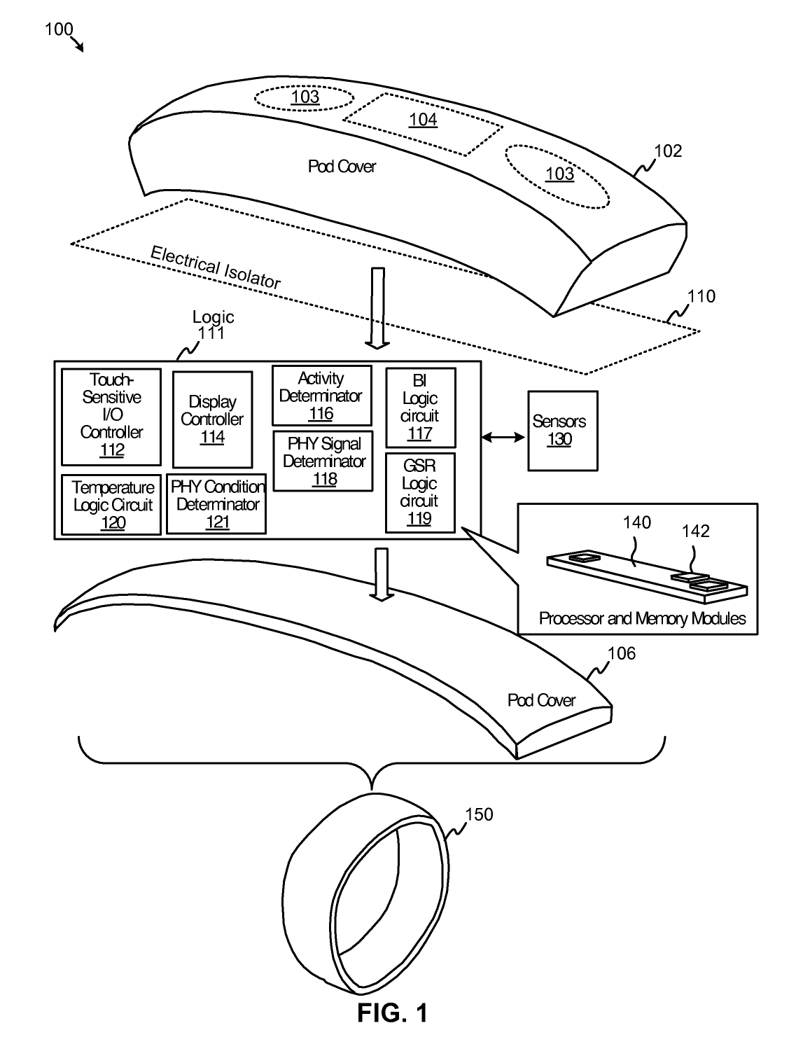

FIG. 1 is an exploded view of an example of a wearable pod having, for example, an opaque surface, according to some embodiments. Diagram 100 depicts a pod cover 102 and a pod cover 106 configured to house circuitry 142 including one or more substrates 140 (e.g., printed circuit board, such as a flex circuit board) and any number of associated processor modules, semiconductor devices (e.g., sensors, radio frequency or “RF” transceivers, etc.), electronic components (e.g., capacitors, resistors, sensors, etc.), and memory modules. Diagram 100 depicts the structure and/or functionality of circuitry 142 as logic 111. According to some embodiments, pod cover 102 is shown to include touch-sensitive portions 103 and a display portion 104 disposed in a top surface 102a that predominantly includes an opaque material, such as a metal, a nontransparent plastic, etc. Note that touch-sensitive portions of pod cover 102 need not be limited to portions 103. For example in some examples, display portion 104 may also be configured to function as touch-sensitive portion 103. As another example, one or more sides and/or surfaces of pod cover 102 can be implemented as a touch-sensitive portion. An electrical isolator 110 is shown in diagram 100, whereby electrical isolator 110 is configured to electrically isolate touch-sensitive portions 103 from logic 111, pod cover 106, and other components or elements of a wearable pod. In some examples, isolator 110 can electrically isolate pod cover 102 and its constituent materials from logic 111, pod cover 106, and other components or elements of a wearable pod.

According to some embodiments, pod cover 102, logic 111, and pod cover 106 can be assembled to form a wearable pod that can be integrated into a band 150 of one or more attachment members (e.g., one or more straps, etc.) to form a wearable device. A wearable pod and/or wearable device may be implemented as data-mining and/or analytic device that may be worn as a strap or band around or attached to an arm, leg, ear, ankle, or other bodily appendage or feature. In other examples, a wearable pod and/or wearable device may be carried, or attached directly or indirectly to other items, organic or inorganic, animate, or static. Note, too, that wearable pod enough be integrated into band 150 and can be shaped other than as shown in FIG. 1 for example, a wearable pod circular or disk-like in shape with display portion 104 disposed on one of the circular surfaces.

According some embodiments, logic 111 includes a number of components formed in either hardware or software, or a combination thereof, to provide structure and/or functionality for elemental blocks shown. In particular, logic 111 includes a touch-sensitive input/output (“I/O”) controller 112 to detect contact with portions of pod cover 102, a display controller 114 to facilitate emission of light, an activity determinator 116 configured to determine an activity based on, for example, sensor data from one or more sensors 130 (e.g., disposed in an interior region between pod covers 102 and 106, or disposed externally). A bioimpedance (“BI”) circuit 117 may facilitate the use of bioimpedance signals to determine a physiological signal (e.g., heart rate), and a galvanic skin response (“GSR”) circuit 119 may facilitate the use of signals representing skin conductance. A physiological (“PHY”) signal determinator 118 may be configured to determine physiological characteristic, such as heart rate, among others, and a temperature circuit 120 may be configured to receive temperature sensor data to facilitate determination of heat flux or temperature. A physiological (“PHY”) condition determinator 121 may be configured to implement heat flux or temperature, or other sensor data, to derive values representative of a condition (e.g., a biological condition, such as caloric energy expended or other calorimetry-related determinations). Logic 111 can include a variety of other sensors, some which are described herein, and others that can be adapted for use in the structures described herein.

Touch-sensitive portions 103 are configured to detect contact by an item or entity as an input to logic 111. According to some embodiments, touch-sensitive portions 103 are coupled to touch-sensitive input/output (“I/O”) controller 112, which is configured to detect a capacitance value at one or more touch-sensitive portions 103. Further, touch-sensitive I/O controller 112 can be configured to detect a change from one value of capacitance relative to a touch-sensitive portion 103 to another value of capacitance. If the value of capacitance is within a range of capacitive values that define a contact as a valid “touch,” touch-sensitive I/O controller 112 can generate a signal including data describing touch-related characteristics of the contact. Examples of a range of capacitance values include approximate values of 0.75 pF to 2.4 pF, or other equivalent values. Further, examples of items or entities for which a “touch” is detected can include tissue (e.g., a finger), a capacitive stylus (or the like), etc. Touch-related characteristics, for example, can include a number of touches per unit time, a time interval during which a touch is detected, a pattern of different durations per unit time (e.g., such as Morse code or other simplified schemes).

While touch-related characteristics may be a function of time, various implementations need not so limited. For example, consider an implementation of pod cover 102 with multiple touch-sensitive portions 103. Touch-related characteristics in this case may also include an order of touching touch-sensitive portions 103 to simulate, for instance, a swiping gesture from left-to-right or right-to-left. Other types-related characteristics are possible.

Display controller 114 is configured to receive signals indicative of, for example, a mode of operation of a wearable pod, a value associated with a physiological signal (e.g., a heart rate), a value associated with an activity (e.g., a number of steps, a percentage of completion for a goal, etc.), and other similar information. Further, display controller 114 is configured to cause selective emission of light via display portion 104, the emission of light having certain characteristics, such as symbol shapes and colors, to convey specific information.

Bioimpedance circuit 117 includes logic in hardware and/or software to apply and receive electrical signals include bioimpedance-related information, which physiological signal determinator 118 can receive and determine one or more physiological characteristics. For example, physiological signal determinator 118 can extract a heart rate and/or a respiration rate from one or more bioimpedance signals. One or more examples implementing bioimpedance signals to derive physiological signal values are described in U.S. patent application Ser. No. 13/831,260 filed on Mar. 14, 2013, U.S. patent application Ser. No. 13/802,305 filed on Mar. 13, 2013, and U.S. patent application Ser. No. 13/802,319 filed on Mar. 13, 2013, all of which are incorporated by reference herein. A galvanic skin response circuit 119 includes logic in hardware and/or software to apply and receive electrical signals that includes skin conductance-related information. According to some embodiments, logic 111 is configured to use electrodes in a first mode to determine bioimpedance signals, and to use at least one for the electrodes in a second mode to determine galvanic skin conductance. Therefore, one or more electrodes may have multiple functions or purposes. Temperature circuit 120 includes logic in hardware and/or software to apply and receive electrical signals that includes thermal energy-related information, which, for example, physiological condition determinator 121 can use to derive values representative of a condition of a user, such as a caloric burn rate, among other things.

Examples of other sensors 130 include accelerometer(s), an altimeter/barometer, a light/infrared (“IR”) sensor, an audio sensor (e.g., microphone, transducer, or others), a pedometer, a velocimeter, a GPS receiver, a location-based service sensor (e.g., sensor for determining location within a cellular or micro-cellular network, which may or may not use GPS or other satellite constellations for fixing a position), a motion detection sensor, an environmental sensor, a chemical sensor, an electrical sensor, a mechanical sensor, a light sensor, and others.

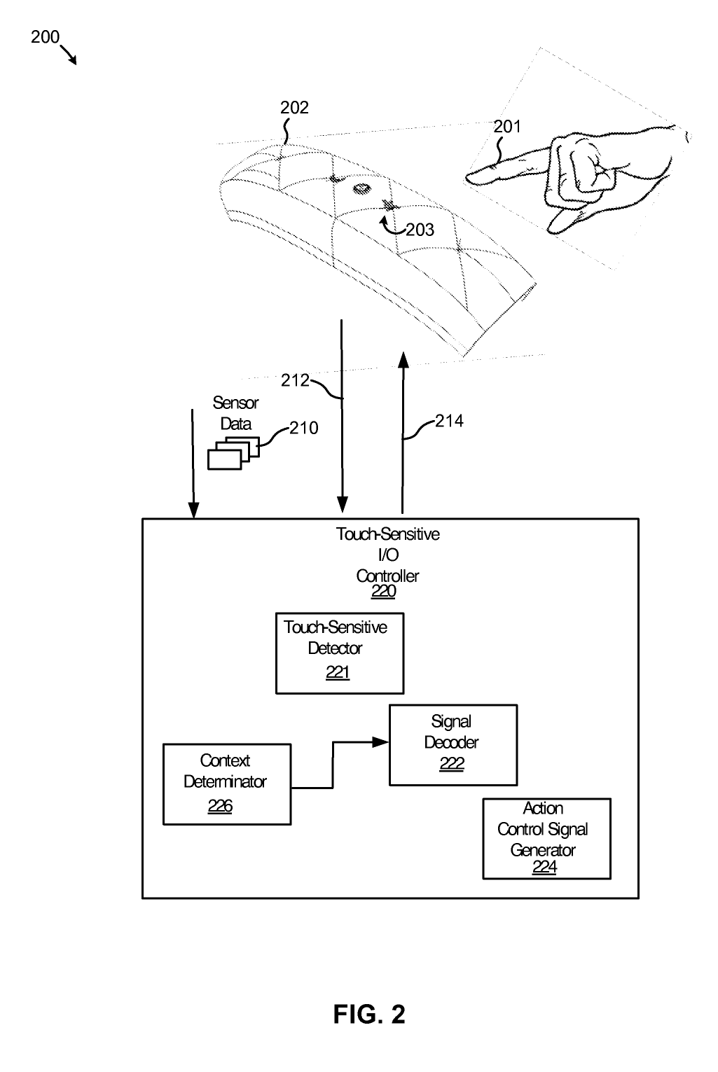

FIG. 2 is a diagram depicting a touch-sensitive I/O controller, according to some embodiments. Diagram 200 depicts a touch-sensitive I/O controller 220 including a touch-sensitive detector 221, a signal decoder 222, an action control signal generator 224 and a context determinator 226. According to some embodiments, touch-sensitive detector 221 is coupled to a surface of a pod cover 202 and is configured to receive one or more signals via a conductive path 212, the one or more signals indicating a value of detected capacitance. A detected capacitance value can be determined responsive to contact by tissue (e.g., finger 201) with a portion of pod cover 202. Touch-sensitive detector 221 can also be coupled to pod cover 202 to detect a capacitive value based on contact in a display portion 203. In some examples, a surface of a pod cover 202 can include to a surface portion of a substrate, such as a metal substrate, regardless of whether pod cover 202 is covered in a coating (e.g., anodized or the like).

Signal decoder 222 is configured to receive one or more signals to decode or otherwise determine a command based on one or more detected capacitance values, according to some examples. As an example, signal decoder 222 may decode an enable command to enable decoding of one or more detected capacitance signals, thereby enabling a wearable pod to acquire user input via touch. Or, signal decoder 222 may decode a disable command to disable decoding of one or more signals detected capacitive signals, thereby preventing inadvertent contact (e.g., during sleep, etc.) from being interpreted as being a valid touch. Further, signal decoder 222 is further configured to decode a number of detected capacitive values to identify patterns of the detected capacitance values, whereby signal decoder 222 can decode a pattern of detected capacitance values as a specific command. Signal decoder 222 can determine a pattern of detected capacitance values based on, for example, a quantity of detected capacitance values per unit time, a time interval during which a detected capacitance value is detected, a pattern of varied durations per unit time and/or different detected capacitance values, etc. Thus, signal decoder 222 can decode detected capacitance values to determine a command as a function of time.

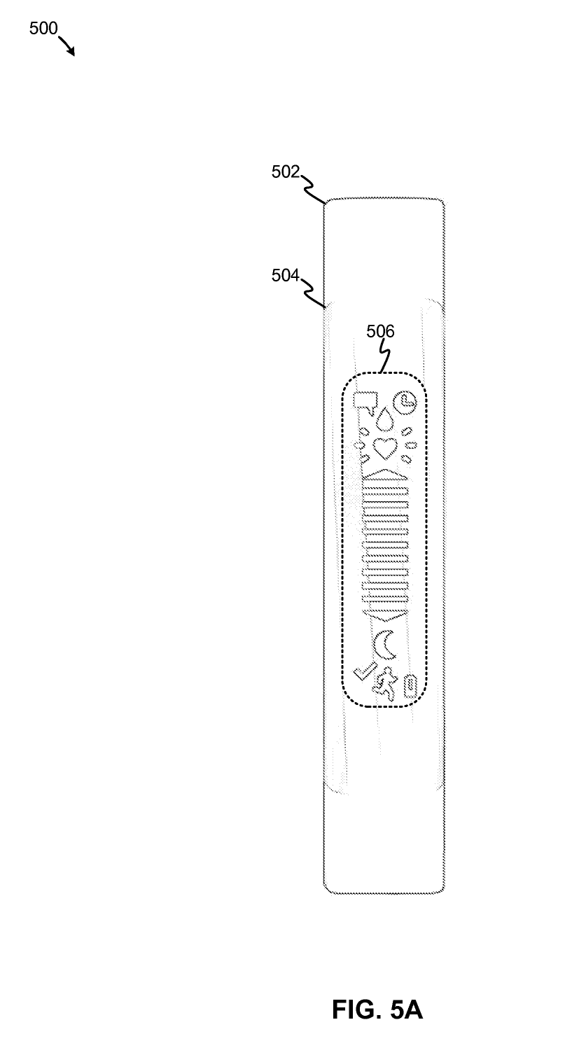

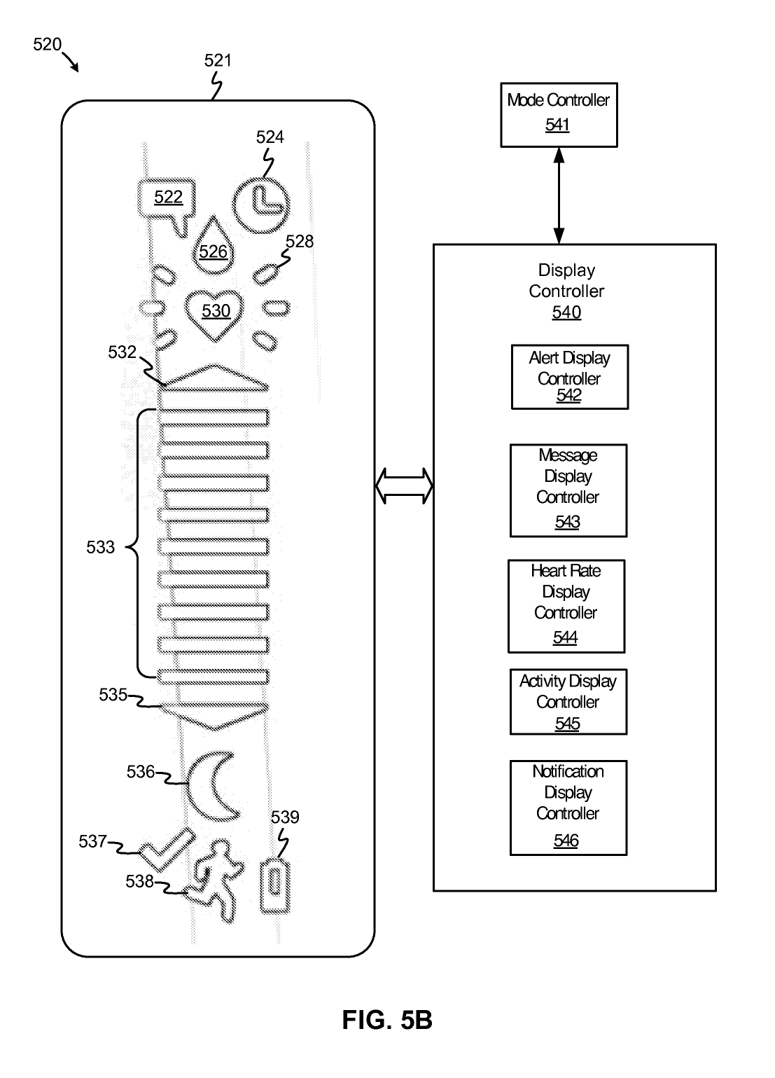

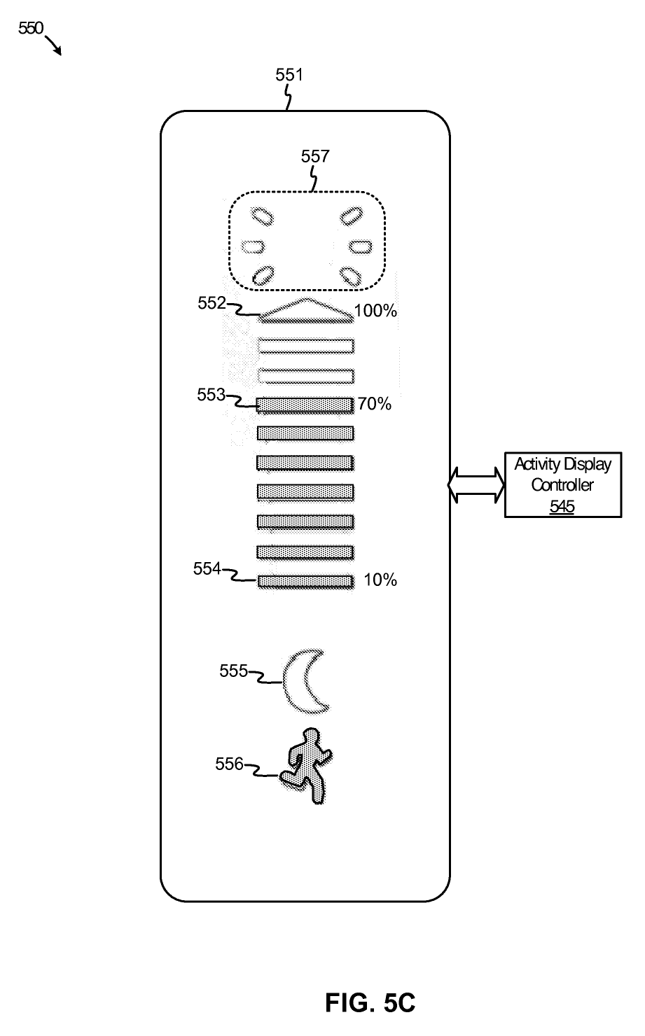

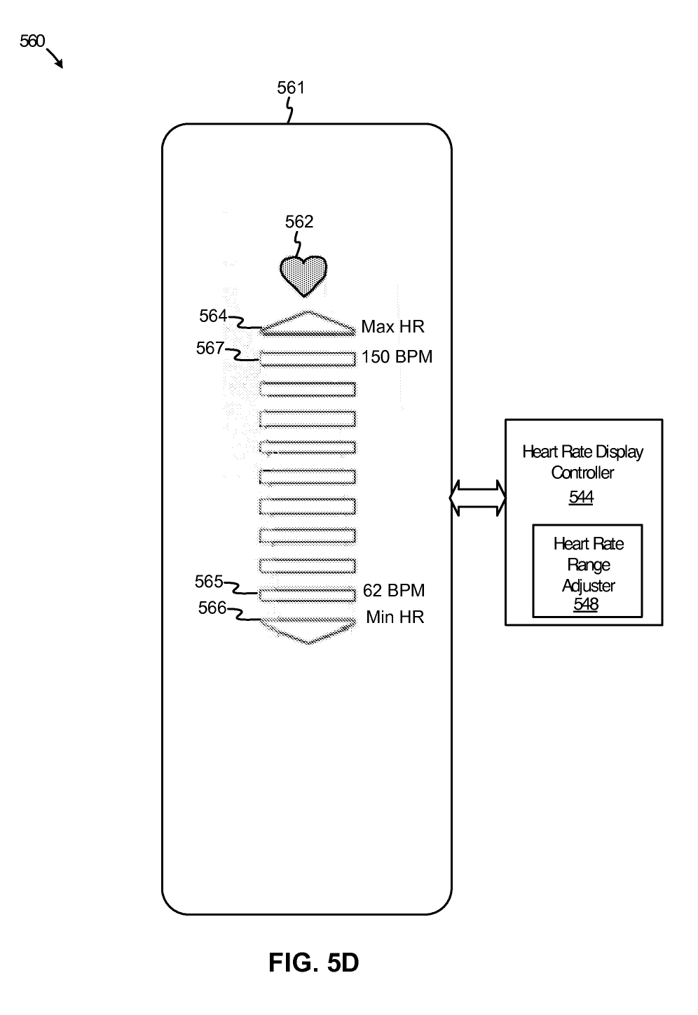

Further to the above-described examples, signal decoder 222 can identify a first pattern of detected capacitance values associated with a first command to, for example, disable implementation of a subset of subsequent detected capacitance values, thereby disabling implementation by a wearable pod of subsequent detected capacitance values (e.g., turning “off” a ‘cap touch’ input feature to exclude inadvertent touches). Signal decoder 222 can identify a second pattern of detected capacitance values associated with a second command (e.g., a mode command) to, for example, transition the wearable pod to a mode of operation as a function of a capacitance pattern. Also, signal decoder 222 can transmit a signal indicating a mode command to action control signal generator 224, which can directly or indirectly effectuate a change in mode of operation. Or, in some other examples, a mode controller of FIG. 5B can be implemented to cause a change in mode. In some embodiments, action control signal generator 224 can cause, directly or indirectly, a particular pattern of the light 214 to be emitted via display 203 based on the decoded command.

Context detector 226, which is optional, may be configured to receive sensor data 210 and/or data indicating a state of activity (e.g., whether an activity is running, sleeping, or the like). Based on sensor data 210 and/or activity state data, context detector 226 can detect context of the wearable pod (e.g., a type of activity in which as user is engaged). Context detector 226 can transmit context data to signal decoder 222, which, in turn, can be configured to implement a first set of commands based on one pattern of capacitance values based on a first context (e.g., a person is sleeping), and is further configured to implement a second set of commands based on the identical pattern of detected capacitance value based on a second context (e.g., a person is moving). Thus, context detector 226 can enable a wearable pod to generate different commands using the same pattern of detected capacitance values based on different contexts.

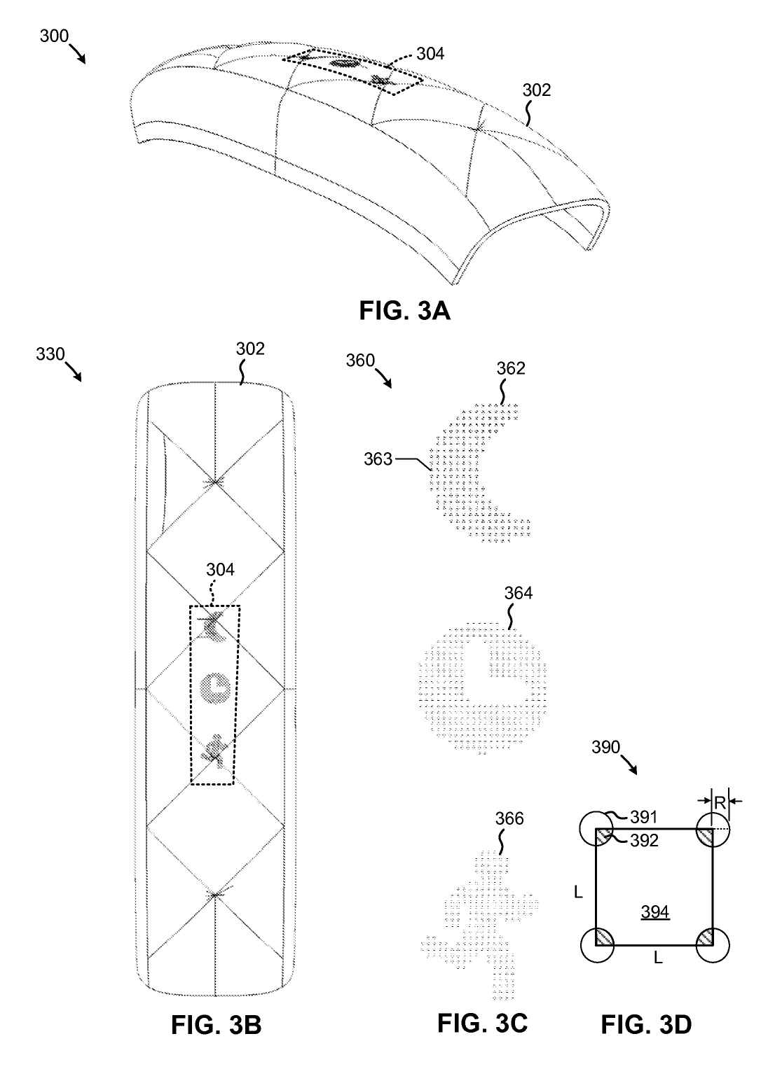

FIGS. 3A to 3D are diagrams depicting various aspects of an interface of a wearable pod, according to some examples. FIG. 3A is a diagram 300 depicting a perspective view of a pod cover 302 including a display portion 304 of an interface. As an interface of a wearable pod, an interface can include a portion of pod cover 302 that is configured to either accept user inputs or provide an output to a user, or both. Therefore, display portion 304 can be configured to both output information to a user and accept user input. According to some embodiments, pod cover 302 includes a conductive material, such as metal, to facilitate touch-sensitive interfacing with a wearable pod. As shown, pod cover 302 has an elongated shape and includes at least a top surface into side surfaces, all of which are configured to form an interior region into which interior components, such as circuitry, can be disposed. Note that various other embodiments, pod cover 302 can be formed of any shape including, for example, a circular-shaped cover. In some cases, pod cover 302 can include a surface treatment (e.g., stamped pattern) including cosmetically-pleasing features.

FIG. 3B is a diagram 330 depicting a top view of pod cover 302 including display portion 304. According to some examples, display portion 304 includes pixelated symbols formed in an opaque material, such as a metal, a nontransparent plastic, etc. Further, the pixelated symbols may be formed in material to form a predominately opaque material. Other portions of pod cover 302 can also be formed in an opaque material.

FIG. 3C is a diagram 360 depicting an enhanced view of display portion 304. As shown, a display portion can include pixelated symbol 362 representing a crescent moon (e.g., related to sleep activities and characteristics), pixelated symbol 364 representing a clock (e.g., related to reminders or information regarding various things, such as sleep activities and workout activities), and pixelated symbol 366 representing a running person (e.g., related to movement-related activities and characteristics). Further to FIG. 3C, pixelated symbols 362, 364, and 366 are shown to include arrangements of symbol elements 363. According to some embodiments, a symbol element 363 may include a micro-perforation. Thus, pixelated symbols 362, 364, and 366 may include arrangements of micro-perforations and/or emissions of light therefrom. The micro-perforations facilitate a display implementing an opaque material or predominately opaque material, whereby a micro-perforation is difficult to see, or is otherwise not visible to most individuals without magnifying equipment.

FIG. 3D is a diagram 390 that depicts an example of a density of micro-perforations per unit area in a predominately opaque material. As shown, a unit surface area 394 of an opaque material, such as anodized aluminum, is shown to include four (4) quarters 392 of micro-perforation. Area 394 can be defined by the product of the side lengths, L, whereas the area 392 is one-fourth (¼) an area defined by a circular (in this example) having a radius, R. In one example, micro-perforations 391 have diameters of 30 microns (e.g., 0.03 mm) and L is 100 microns (e.g., 0.10 mm). Thus, micro-perforations 391 in this example may account for about 7% of unit area 394, and the opaque material is approximately 93% of unit area 394. With these dimensions, the density of micro-perforations is approximately 100 micro-perforations per square millimeter. Other micro-perforation sizes and densities may be implemented.

According to one example, a predominately opaque material as a portion of a surface can be composed of about 93% opaque material and 7% transparent material per unit area. In another example, a predominately opaque material as a portion of a surface can be composed of about 85% to 98% opaque material per unit area (e.g., approximately 16 to 44 microns), whereas in other examples a predominately opaque material can be composed of about 67% to 99% unit area. In at least one example, a predominately opaque material can be composed of 51% opaque material per unit area. Accordingly, the diameters of micro-perforations 391 can vary so long as the area consumed by micro-perforations 391 do not, for example, consume more than 49% of an opaque material. Note while micro-perforations 391 are depicted as being circular, the size and shape of micro-perforations 391 are not so limited.

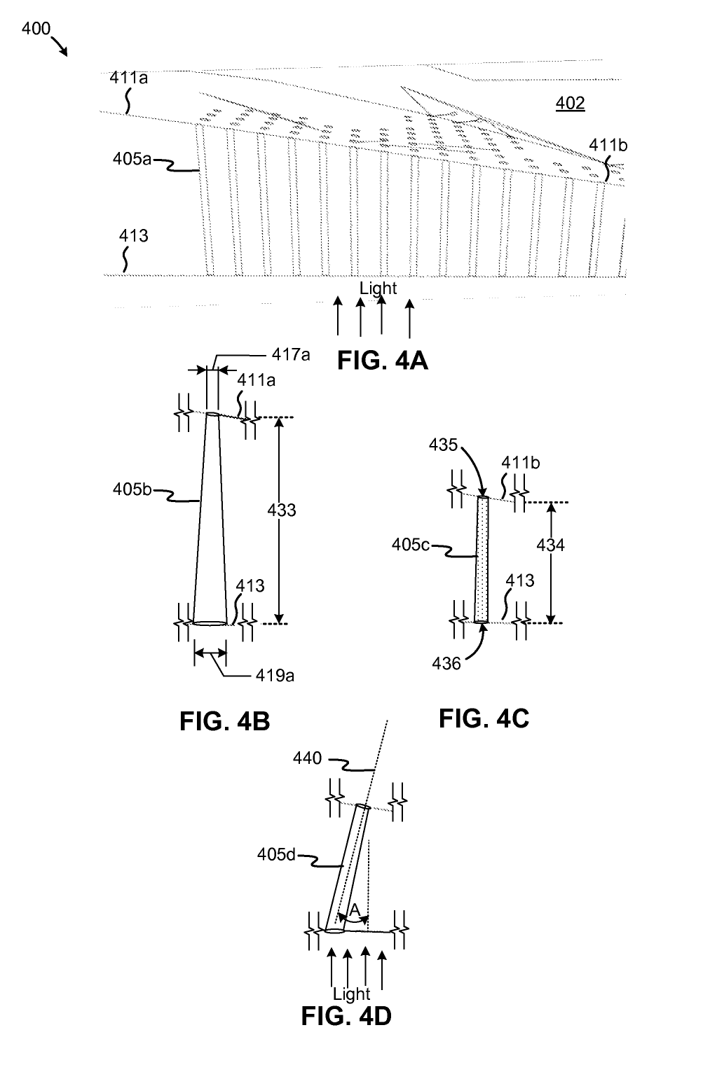

FIGS. 4A to 4D depict examples of micro-perforations, according to some examples. FIG. 4A is a diagram 400 depicting a cross-section of a pod cover 402 and micro-perforations 405a extending from an outer surface 411a, 411b to an inner surface 413, which is adjacent to light sources (not shown) that transmit light for emission via micro-perforations 405a. FIG. 4B depicts an example of a tapered micro-perforation, according to some examples. Tapered micro-perforation 405b is configured to include an opening having a diameter or size 419a in inner surface 413, whereas another opening may have a diameter or size 417a in outer surface 411a. As shown, diameter 417a is less than diameter 419a. According to some embodiments, the ratio of diameter 419a to diameter 417a can vary based on the depth 433 of micro-perforation 405b. In one example, the ratio can be larger as the depth 433 increases. In another example, the differences in diameters 417a and 419b can vary by +/−10 microns. A larger-size diameter 419a can increase collection of light or scattered light rays from a light source such as one or more LEDs.

FIG. 4C depicts an example of another tapered micro-perforation 405c. In this example, micro-perforation 405c has an opening in inner surface 413 having a diameter 436 and another opening an outer surface 411b having a diameter 435. In one example, size of diameter 436 may be slightly larger than diameter 435 as a function of depth 434, which is less than depth 433 of FIG. 4B. An example of one of depths 433 and 434 is approximately 300 microns, and can vary by 50% (or greater in some cases). Or, in some examples diameters 435 and 436 are equivalent. The shading of micro-perforation 405c may depict optically-transparent material disposed therein. In some examples, the optically-transparent material may be an optical adhesive, epoxy resin, or sealant having relatively high refractive indices ranging from 1.50 to 1.56, or higher. For example, the refractive index may range from 1.57 to 1.60, or greater. Rather, the optically-transparent material or filler disposed in micro-perforation 405c may be configured to transmit 95% visible light (e.g., for sidewall areas determined by a diameter of a micro-perforation). The epoxy or filler material may prevent humidity and other environmental factors from affecting internal LEDs (or the like) and/or circuitry. FIG. 4D depicts an example of an angled micro-perforation, according to some embodiments. As shown, micro-perforation 405 is formed to focus emission of light along at line 440 at an angle “A,” to focus light in a direction a user's eyes most likely are positioned. In this configuration, angle A places line 440 non-orthogonal to the initial direction of emission from below an inner surface of pod cover 402. Angle A thereby assists in directing luminosity toward a user and reduces the visibility of such information to other persons' eyes at other positions.

FIGS. 5A to 5D are diagrams depicting another example of a display portion for a wearable pod, according to some embodiments. Diagram 500 depicts a wearable pod including a pod cover 504 integrated or otherwise coupled (e.g., detachably coupled) to a band 502 or strap 502 to form a wearable device. In this example, display portion 506 includes a variety of symbols having multiple functions to convey multiple types of information based on a mode of operation, a type of activity, a contacts, etc. Display portion 506 can include symbol elements composed of micro-perforations. Further, the symbol elements may emit different colors of light based on the types of information being conveyed.

FIG. 5B is a diagram depicting another display portion interacting with a display controller, according to some examples. Diagram 520 depicts a display portion 521 that includes a display formed in predominately opaque material, whereby the symbol elements formed therein may include various arrangements of micro-perforations. Display controller 540 includes either hardware or software, or a combination thereof, to implement an alert display controller 542, a message display controller 543, a heart rate display controller 544, an activity display controller 545, and a notification display controller 546. Further, display controller 540 can be coupled to a mode controller 541, which is configured to provide mode data to display controller 540. The mode data can describe a mode of operation, a context, an activity, or a condition in which a wearable pod is operating. Responsive to the mode data, display controller 540 can implement one or more of the above-described controllers 542 to 546 to provide mode-specific via display portion 521. As an example, display controller 540 can identify a subset of light sources and/or micro-perforations to emit light through an arrangement of micro-perforations constituting one or more symbols indicative of a value of a physiological signal, such as a heart rate.

Alert display controller 542 is configured to implement symbols 522, 524, and 526 to provide alerts to a user. Upon detecting a notification to check an application residing, for example, on a mobile computing device, alert display controller 542 may be configured to cause symbol 522 to emit light. Note that according to some embodiments, an illuminated symbol 522 can alert a user to the availability of an insight. The term “insight” can refer to, for example, data correlated among a state of user (e.g., number of steps taken, number of our slapped, etc.) and other sets of data representing trends, patterns, and correlations to goals of a user (e.g., a target value of a number of steps per day) and/or supersets of generalized (e.g., average values) of anonymized data for a population at-large. With insight data, the user can understand how an activity (e.g., running, etc.) can affect other aspects of health (e.g., amount of sleep as a parameter). In some embodiments, insight data can include feedback information. For example, insights can include data derived by the structures and/or functions set forth in U.S. Pat. No. 8,446,275, which is herein incorporated by reference to illustrate at least some examples.

Should a reminder or notification arise that requires a user to hydrate or consume water, alert display controller 542 is configured to cause symbol 526 to illuminate. Alert display controller 542 is configured to maintain calendared events and times, and is further configured to receive reminders from another computing device, such as a mobile phone. When emitting light, symbol 524 may alert a user as a reminder to undertake one of variety of actions based on time or a calendar event. Further, symbol 524 may illuminate with different colors and/or with other symbols in display portion 521 to indicate one or more of a sleep reminder, a workout reminder, a meal reminder, a custom reminder, and the like.

Message display controller 543 is configured to convey a message via display portion 521. While symbols 528 and 530 can have multiple functionalities, the following descriptions are in the context of conveying messages. For example, message display controller 543 can cause symbol 528 to emit light responsive to detecting that the wearable pod and/or a mobile computing device has received, or is receiving, a message of encouragement (electronic “dopamine”) from a friend or family regarding a user's state or activity. Message display controller 543 is configured to detect that a friend or family member has communicated a “love tap” (e.g., a gesture, like a squeeze or tap of a wearable pod in the other's possession). To convey the love tap, message display controller 543 is configured to cause symbol 530 and symbols 528 to emit light.

Heart rate display controller 544 is configured to receive physiological signal information based on one or more sensors. For example, the physiological signal information can specify a heart rate related to, for example, a particular mode of operation (e.g., at rest, asleep, moving, running, walking, etc.). Upon receiving data representing a heart rate, heart rate display controller 544 can select symbols 530, 532, 535 in one or more of symbols 533 to convey heart rate information. In some cases, symbol 534 indicates a minimum heart rate and symbol 532 indicates a maximum heart rate. In this context, symbol 530 may indicate a heart rate measurement is being performed or has been performed.

Activity display controller 545 is configured to receive motion or movement-related signal information based on one or more sensors. For example, the motion data can specify a number of motion units (e.g., steps) relative to a goal of total motion units, or the motion data can specify percentage of completion of a user's activity goal (e.g., a number of steps per day). As such, activity display controller 545 is configured to select a number of symbols 533 to specify an amount of progress is being made to a goal. Also, activity display controller 544 can select either symbol 536 to specify progress toward a sleep goal or symbol 538 to specify progress to a movement goal.

Notification display controller 546 is configured to receive data representing a power level of a battery supplying power to a wearable pod. Based on an amount of charge stored in the battery, the notification display controller 546 can cause symbol 539 to emit light to indicate a charge level. Notification display controller 546 is also configured to receive data representing an indication that a user's action either regarding a wearable pod or a mobile computing device (e.g., an application) has been implemented. To confirm implementation, the notification display controller 546 is configured to emit light via symbol 537.

FIG. 5C is a diagram depicting an example of an activity display controller interacting with a display portion, according to some examples. Diagram 550 depicts a display portion 551 coupled to an activity display controller 545. Activity display controller 545 can receive data originating as accelerometer signals indicative of an activity, and can determine a value indicative of an activity (e.g., an amount of steps toward a goal). Activity display controller 545 can also determine whether sleep-related information is to be displayed or whether movement-related information as to be displayed, and can identify a quantity of lights from which to emit light, the quantity of lights being proportional to a value indicative of an activity. As shown, activity display controller 545 is configured to convey information related to a movement-related activity, and thus causes symbol 556 to illuminate (i.e., shown as shaded). Activity display controller 545 is configured to determine a user's progress relative to a goal and selects a subset of symbols from which to emit light. As shown, a user is at 70% toward a goal of 100%. Therefore, activity display controller 545 causes symbol 554 (e.g., 10%), symbol 553 (e.g., 70%), and intervening symbols to illuminate (i.e., shown as shaded). Note that activity display controller 545 may illuminate symbol 552 upon reaching a goal, and may further illuminate symbols 557 to indicate a user's goal is surpassed (e.g., a user is at 110% of a goal).

FIG. 5D is a diagram depicting an example of a heart rate display controller interacting with a display portion, according to some examples. Diagram 560 depicts a display portion 561 coupled to a heart rate display controller 544. Heart rate display controller 544 can determine that a heart rate is to be displayed, and can identify a quantity of lights and/or micro-perforations from which to emit light, the quantity of lights being proportional to a heart rate. As shown, heart rate display controller 544 is configured to convey information related to heart rate, and thus causes symbol 562 to illuminate (i.e., shown as shaded). Heart rate display controller 544 is configured to determine a user's heart rate relative to a minimum heart rate (“Min HR”) associated with symbol 566 and to a maximum heart rate (“Max HR”) associated with symbol 564. Further, heart rate display controller 544 is configured to determine an approximate value of the heart rate relative to gradations from, for example, from 62 beats per minute (“BPM”), which is associated with symbol 565, to 150 BPM, which is associated with symbol 567. Note that in some examples, each symbol illuminated from symbol 565 indicates an additional 11 beats per minute (e.g., +/−2 to 4 bpm). In some embodiments, heart rate display controller 544 can include a heart rate range adjuster 548 that is configured to track a user's maximum and minimum heart rates during one or more activities and can adjust the maximum heart rate values and minimum heart rate values associated with symbols 567 and 566, respectively. Therefore, based on the wellness and health of a user's cardiovascular system and other factors, heart rate range adjuster 548 can customize the gradations of symbols from symbol 565 to symbol 567 for a particular user. Note that the examples of the above-described display controllers are non-limiting examples can include controllers for displaying other information, such as a rate at which calories are burned, among other things.

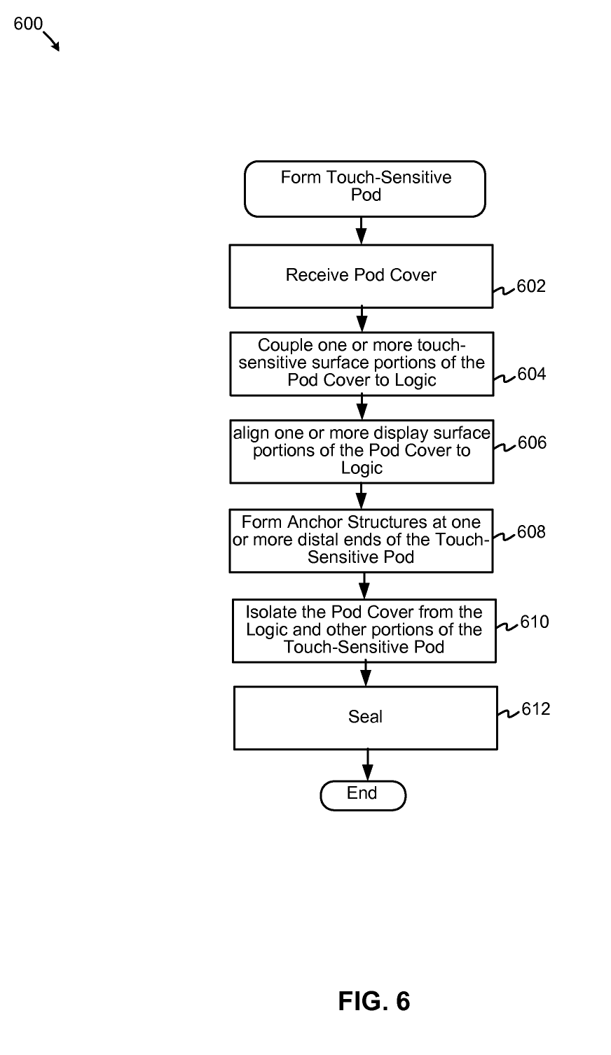

FIG. 6 is an example of a flow to form a wearable pod, according to some embodiments. At 602, a pod cover is received. For example, flow 600 can being by receiving a top pod cover including interface portions including one or more touch-sensitive portions and one or more display portions. In some examples, a top pod cover is configured to have a surface oriented away (e.g., away from a surface of a user) from a point of attachment to or positioning adjacent a user. At 604, one or more touch-sensitive surface portions may be coupled to logic for detecting contact upon the touch sensitive surface. At 606, a display portion is aligned adjacent to one or more sources of light such that perforations of the display portion are aligned to respective light sources. The one or more sources of light may be configured to emit light via a predominately opaque surface, at least in some examples. At 608, anchor portions or structures are formed at one or more distal ends of a touch-sensitive wearable pod. In some examples, a wearable pod and its top pod cover can be elongated in dimensions such that the wearable pod has two or more sides longer than the other two or more sides. In one case, the longer sides extend across a surface of an appendage (e.g., across a wrist) of a user. Shorter sides can be at the distal ends relative to the center or centroid of a wearable pod and/or its cradle. At 610, the top pod cover is isolated from logic and other portions of a touch-sensitive wearable pod. At 612, the wearable pod is sealed. For example, a top pod cover can be sealed and a bottom pod cover can be sealed to form a fluid-resistant (e.g., gas-resistant, liquid-resistant, etc.) barrier.

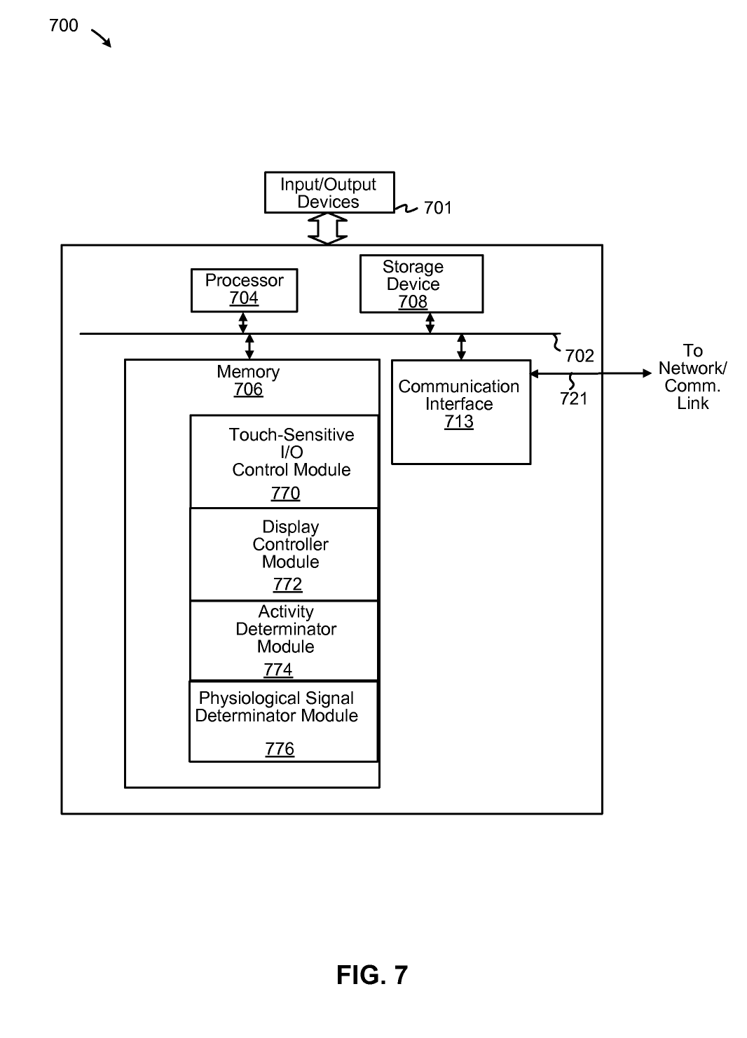

FIG. 7 illustrates an exemplary computing platform disposed in a wearable pod configured to facilitate a touch-sensitive interface in an opaque or predominately opaque surface in accordance with various embodiments. In some examples, computing platform 700 may be used to implement computer programs, applications, methods, processes, algorithms, or other software to perform the above-described techniques.

In some cases, computing platform can be disposed in wearable device or implement, a mobile computing device, or any other device.

Computing platform 700 includes a bus 702 or other communication mechanism for communicating information, which interconnects subsystems and devices, such as processor 704, system memory 706 (e.g., RAM, etc.), storage device 7012 (e.g., ROM, etc.), a communication interface 713 (e.g., an Ethernet or wireless controller, a Bluetooth controller and radio/transceiver, or other logic to communicate via a variety of protocols, such as IEEE 802.11a/b/g/n (WiFi), WiMax, ANT™, ZigBee®, Bluetooth®, Near Field Communications (“NFC”), etc.) to facilitate communications via a port on communication link 721 to communicate, for example, with a computing device, including mobile computing and/or communication devices with processors.

One or more antennas may be implemented as a portion of communication interface 713 to facilitate wireless communication. Also, one or more antennas may be formed external to a wearable pod (e.g., external to a cradle and/or one or more pod covers).

Processor 704 can be implemented with one or more central processing units (“CPUs”), such as those manufactured by Intel® Corporation, or one or more virtual processors, as well as any combination of CPUs and virtual processors. Computing platform 700 exchanges data representing inputs and outputs via input-and-output devices 701, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 700 performs specific operations by processor 704 executing one or more sequences of one or more instructions stored in system memory 706, and computing platform 700 can be implemented in a client-server arrangement, peer-to-peer arrangement, or as any mobile computing device, including smart phones and the like. Such instructions or data may be read into system memory 706 from another computer readable medium, such as storage device 708. In some examples, hard-wired circuitry may be used in place of or in combination with software instructions for implementation. Instructions may be embedded in software or firmware. The term “computer readable medium” refers to any tangible medium that participates in providing instructions to processor 704 for execution. Such a medium may take many forms, including but not limited to, non-volatile media and volatile media. Non-volatile media includes, for example, optical or magnetic disks and the like. Volatile media includes dynamic memory, such as system memory 706.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that constitute bus 702 for transmitting a computer data signal.

In some examples, execution of the sequences of instructions may be performed by computing platform 700. According to some examples, computing platform 700 can be coupled by communication link 721 (e.g., a wired network, such as LAN, PSTN, or any wireless communication link or network, such a Bluetooth LE or NFC) to any other processor to perform the sequence of instructions in coordination with (or asynchronous to) one another. Computing platform 700 may transmit and receive messages, data, and instructions, including program code (e.g., application code) through communication link 721 and communication interface 713. Received program code may be executed by processor 704 as it is received, and/or stored in memory 706 or other non-volatile storage for later execution.

In the example shown, system memory 706 can include various modules that include executable instructions to implement functionalities described herein. In the example shown, system memory 706 includes a touch sensitive I/O control module 770, a display controller module 772, an activity determinator module 774, and a physiological signal determinator module 776, one or more of which can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a wearable pod or one or more of its components (e.g., a touch-sensitive I/O controller or a display controller), or any process or device described herein, can be in communication (e.g., wired or wirelessly) with a mobile device, such as a mobile phone or computing device, or can be disposed therein.

In some cases, a mobile device, or any networked computing device (not shown) in communication with a wearable pod (or a touch-sensitive I/O controller or a display controller) or one or more of its components (or any process or device described herein), can provide at least some of the structures and/or functions of any of the features described herein. As depicted in FIG. 1 and/or subsequent figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, a wearable pod or one or more of its components (e.g., a touch-sensitive I/O controller or a display controller), any of its one or more components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in FIG. 1 (or any subsequent figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, a wearable pod or one or more of its components (e.g., a touch-sensitive I/O controller or a display controller), including one or more components, or any process or device described herein, can be implemented in one or more computing devices that include one or more circuits. Thus, at least one of the elements in FIG. 1 (or any subsequent figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

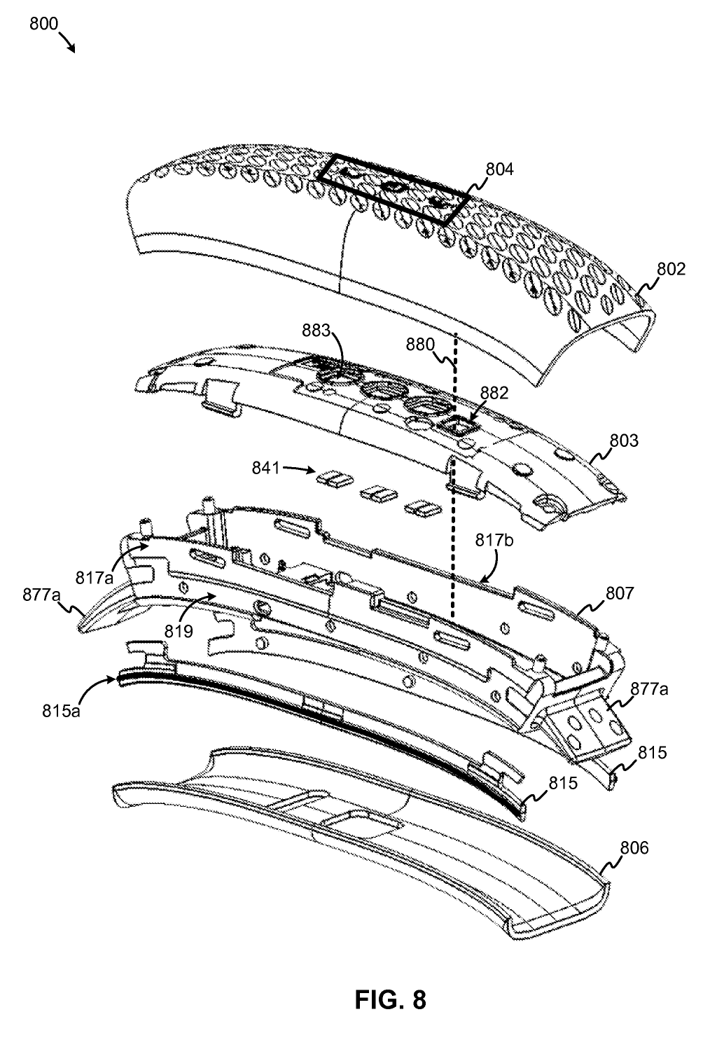

FIG. 8 is an exploded perspective view of an example of a wearable pod having, for example, a metal surface, according to some embodiments. Diagram 800 includes a pod cover 802 composed of conductive material, such as anodized aluminum in which the interior metal is conductive, a pod cover 806 composed of similar material, and a cradle 807 configured to be disposed within an interior region defined by pod covers 802 and 806. Cradle 807 is further configured to house circuitry, including but not limited to a bioimpedance circuit, a galvanic skin response circuit, an RF transceiver (e.g., a Bluetooth Low Energy transceiver), and other electronic components and devices. As shown, cradle 807 includes attachment portions 877a and 877b extending from distal ends of cradle 807, attachment portions 877a and 877b being configured to adhere to an interface material that can constitute one or more anchor portions. Diagram 800 also depicts an isolation belt 815 being formed at a region 819 along or adjacent one or more longitudinal sides (e.g., sides 817a and 817b) of cradle 807. Region 819 along sides 817a and 817b can include one or more edges of pod cover 802 disposed adjacent to one or more edges of pod cover 806. A portion 815a of isolation belt 815 may be disposed between one or more edges of pod cover 802 and one or more edges of pod cover 806 to electrically isolate at least a portion of pod cover 802 from pod cover 806 and/or cradle 807 or other circuitry that need not be related to detecting touch.

Further to FIG. 8, light sources 841, such as light-emitting diodes (“LEDs”) or other sources of light, can be positioned to emit light to respective symbols in display portion 804. Also shown is a mounting frame 803 in which to house light sources 841 in corresponding apertures 883. Mounting frame 803 also includes another aperture 882 to enable a conductive path 880 to extend from pod cover 804 to a touch-sensitive I/O controller circuit (not shown). Other examples of light sources 841 include, but are not limited to, interferometric modulator display (IMOD), electrophoretic ink (E Ink), organic light-emitting diode (OLED), or other display technologies.

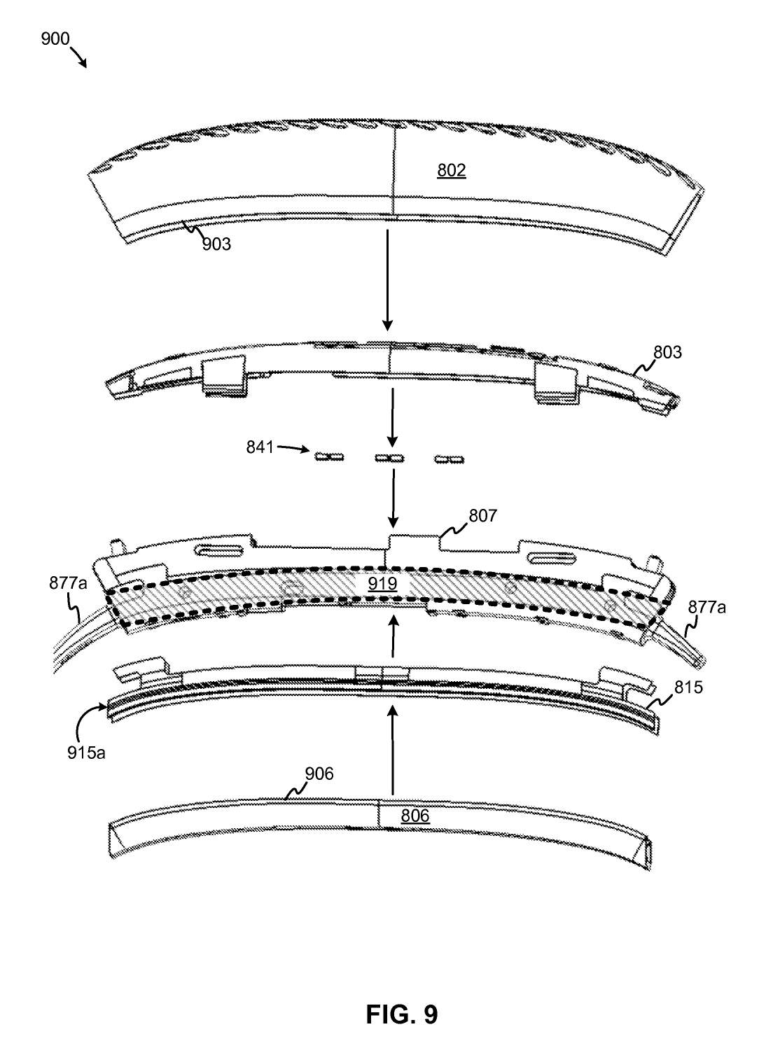

FIG. 9 is an exploded front view of an example of a wearable pod having, for example, a metal surface, according to some embodiments. Diagram 900 depicts elements having structures and/or functions as similarly-named or similarly-numbered elements of FIG. 8. Note that edges 903 of pod cover 802 and edges 906 of pod cover 806 are configured to be adjacent each other, when assembled, at or near region 919. According to some embodiments, a portion 915a (e.g., a ridge or rib) is configured to isolate edges 903 and edges 906 from contacting each other, thereby facilitating touch-sense of capabilities of pod cover 802 (e.g., by preventing electrical shorts or other conditions or phenomena).

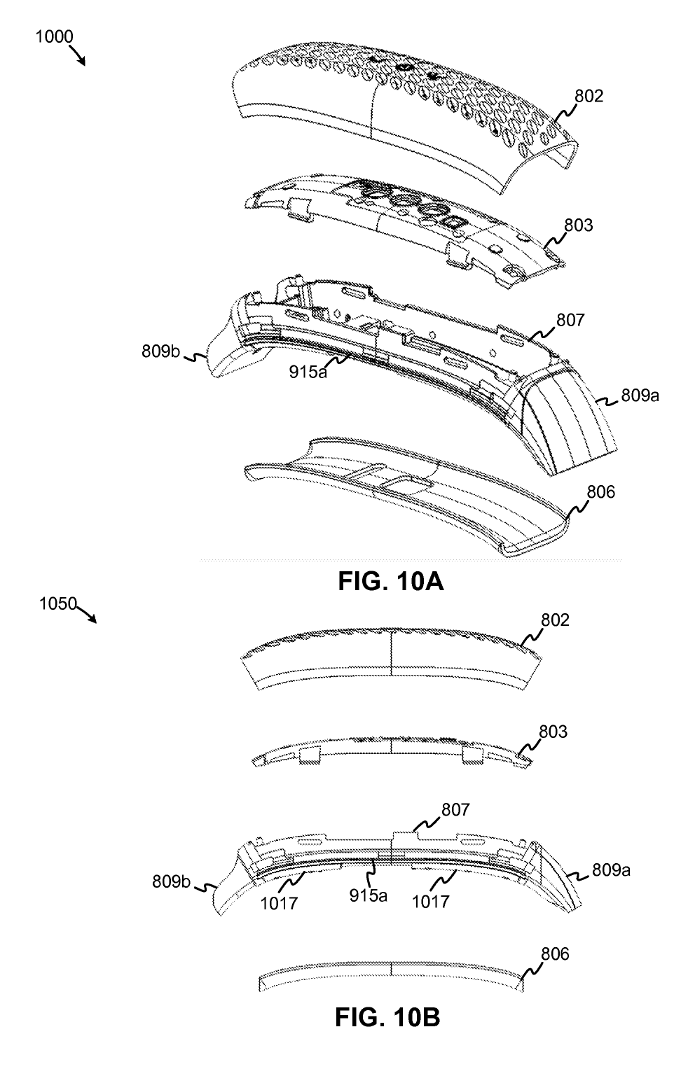

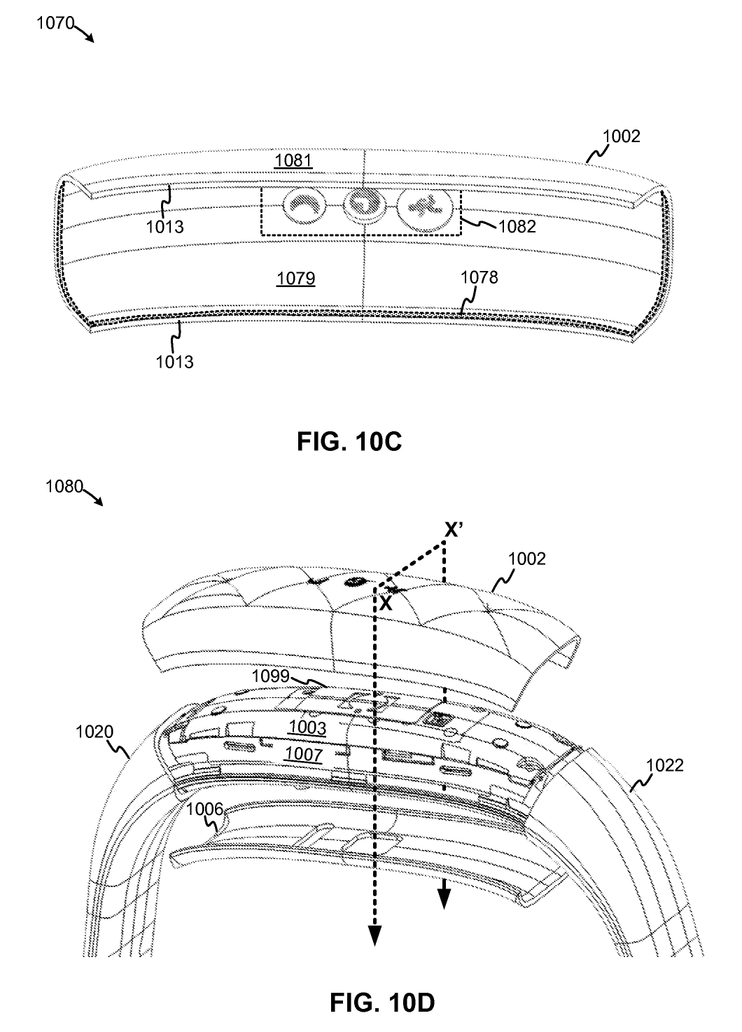

FIGS. 10A to 10B are respective exploded perspective and exploded front views of a wearable pod including anchor portions, according to some embodiments. Diagram 1000 depicts elements having structures and/or functions as similarly-named or similarly-numbered elements of FIGS. 8 and 9. Further, diagram 1000 depicts formation of anchor portions 809a and 809b on attachment portions at the distal ends of cradle 807. Also shown is portion 915a of an isolator belt that can be formed during the formation of anchor portions 809a and 809b. As such, the isolator belt and ridge 915a can be composed of a material used to form portions 809a and 809b. Diagram 1050 depicts elements having structures and/or functions as similarly-named or similarly-numbered elements of FIGS. 8 to 10A. Further, diagram 1050 depicts formation of anchor portions 809a and 809b formed, for example, contemporaneous with the formation of portion 915a of an isolation belt and the formation of an under-layer material 1017, all of which can be composed of a common material (e.g., an interface material). In some embodiments, anchor portions 809a and 809b, portion 915a of an isolation belt, and under-layer material 1017 can be composed of a thermoplastic. For example, the thermoplastic can include polycarbonate or other similar materials.

FIG. 10C is a bottom perspective view of a pod cover implementing a sealant during assembly, according to some embodiments. Diagram 1070 depicts a pod cover 1002 having edges 1013 at least two of which may be disposed adjacent to edges of a bottom pod cover once assembled. Diagram 1070 also shows a sealant 1078 applied on an inner surface portion of pod cover 1002 at or adjacent to one or more edges 1013 of pod cover 1002 to form a fluid-resistant bond to a cradle, an isolation belt, or another structure. In one example, a fluid-resistant bond or barrier is formed to withstand intrusions of water at 1 ATM. Arrangements of micro-perforations 1082 are shown to extend from an inner surface 1079 of a portion of pod cover 1002 to an outer surface 1081 of pod cover 1002.

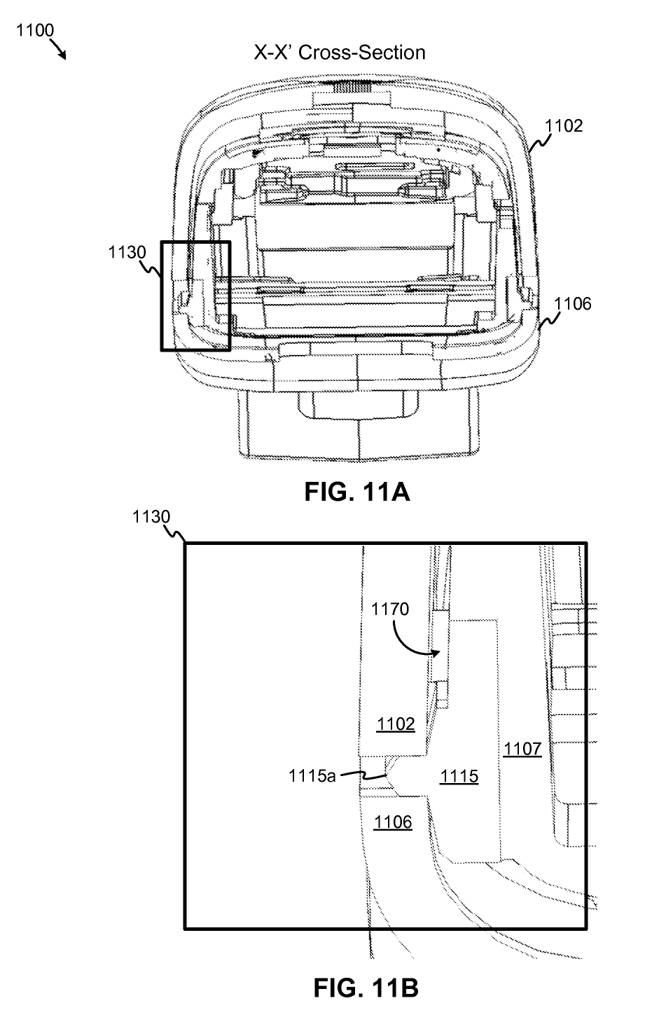

FIG. 10D is a diagram depicting a perspective front view of a wearable pod being assembled as part of a wearable device, according to some embodiments. Diagram 1080 depicts a pod cover 1002 and a pod cover 1006 being brought together to form respective seals to encapsulate the interior structures and circuitry. For example, when assembled, pod covers 1002 and 1006 enclose a light diffuser 1099 (e.g., for diffusing LED-generated light), which may be optional, mounting frame 1003, and cradle 1007. Further, straps 1020 and 1022 are respectively molded on anchor portions 809b and 809a, respectively, whereby anchor portions 809a and 809b are composed of interface materials configured to securely couple cradle 1007 to straps 1020 and 1022. In some embodiments, cradle 1007 comprises a metal material and straps 1020 and 1022 may be composed of a pliable material, such as an elastomer. Note that logic may be disposed within cradle 1007 under mounting frame 1003. Examples of such logic include a bioimpedance circuit disposed in cradle 1007 and configured to couple to a first subset of conductors to receive electrical signals embodying physiological data originating from points in space adjacent to blood vessels in tissue. Also, such logic can include a galvanic skin response circuit disposed in cradle 1007 and configured to couple to a second subset of conductors to receive electrical signals indicative of a conductance value across a portion of tissue. Further, a cross-section view X-X′ of a portion of an isolation belt and the edges of pod covers 1002 and 1006 are depicted in FIGS. 11A and 11B.

FIGS. 11A and 11B are diagrams depicting a cross-section of a portion of an isolation belt, according to some examples. Diagram 1100 is a cross-section view of an assembled wearable pod including a pod cover 1102 attached to interior structures and a pod cover 1106 that is also attached to interior structures. Diagram 1100 also depicts an inset 1130 diagram that includes a cross-section view of an isolation belt. As shown in inset 1130 diagram of FIG. 11B, an isolation belt 1115 formed on or adjacent a cradle 1107. Isolation belt 1115 includes a portion 1115a (or ridge 1115a) that isolates pod cover 1102 from pod cover 1106. According to some embodiments, a sealant 1170 is configured to form a fluid-resistant bond between pod cover 1102 and isolation belt 1115 and/or 1107.

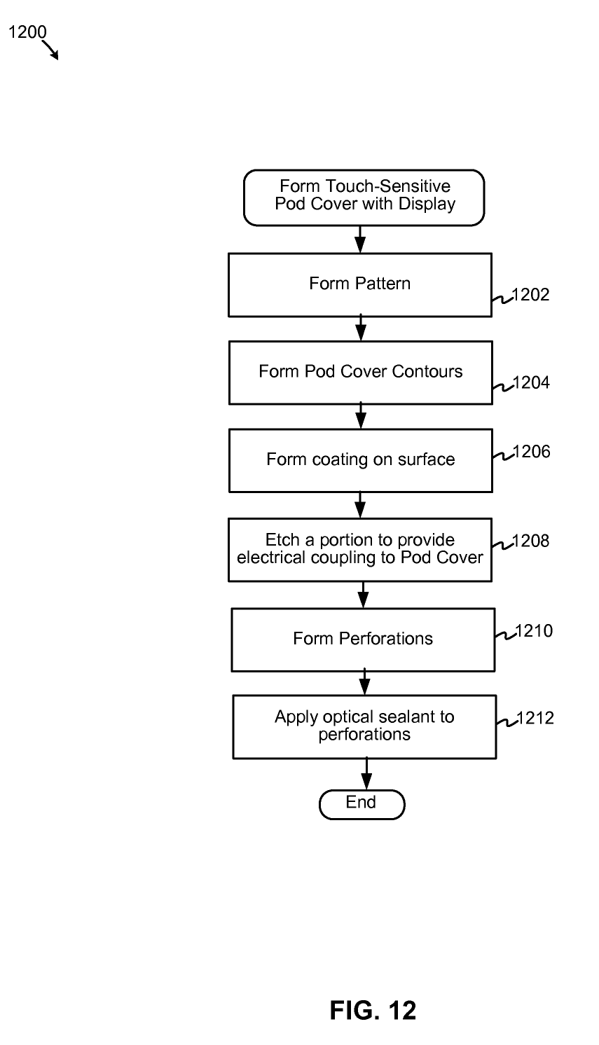

FIG. 12 depicts an example of a flow to form a touch-sensitive pod cover for a wearable pod, according to some examples. Flow 1200 includes forming a pattern at 1202 on a substrate, such as a metal substrate. At 1202, a cosmetic pattern may be formed on a top surface using stamping or CNC-based machine patterning. Prior to 1202, a pod cover can be singulated or separated from other metal. In some examples, the pod cover is an aluminum metal substrate. At 1204, the contours (e.g., the dimensions and spatial characteristics) of the pod cover are formed. Forming the contours include forming shapes of the sides and top surfaces. At 1206, a coating can be formed on the surface of the pod cover. For example, an aluminum pod cover can be anodized to form covered surface on the pod cover. At 1208, a portion of the pod cover is etched to provide access to the aluminum metal substrate (e.g., under the coating) for purposes of electrically coupling the pod cover to, for example, a touch-sensitive I/O control circuit to detect a touch event. For example, a portion of an inner surface of a top pod cover may be etched to facilitate formation of an electrical path to couple one or more touch-sensitive portions of the pod cover to touch-detection logic. At 1210, perforations may be formed in a touch-sensitive portion of the pod cover. In some examples, the perforations and/or micro-perforations can be formed by drilling a number of perforations with a laser to form one or more symbols. At 1212, an optically-transparent sealant can be applied to the perforations and/or micro-perforations for form a display portion.

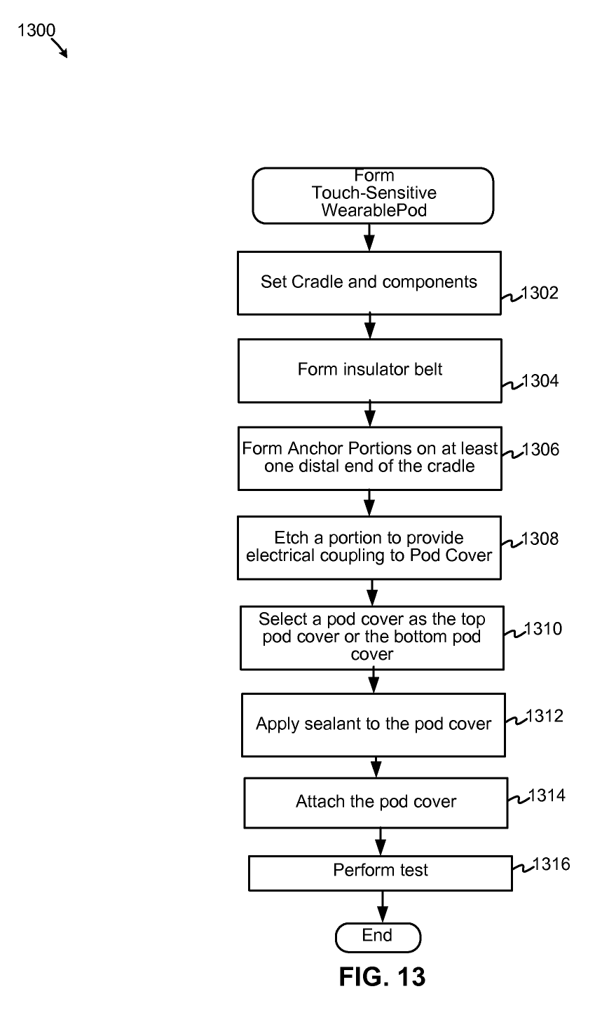

FIG. 13 depicts an example of a flow for a touch-sensitive wearable pod, according to some embodiments. Flow 1300 includes setting a cradle and components in a first mold. For example, the components can include a temperature sensor and pins (e.g., pogo pins) to form a USB connector (or other types of connectors). At 1304, an insulator belt is formed and, at 1306, one or more anchor portions may be formed at one or more attachment portions at one or more distal ends of a cradle. In some examples, the formation of anchor portions includes molding over metal surfaces of the one or more attachment portions with an interface material having properties to facilitate bonding to an elastomer. In at least one example, a thermoplastic material is molded over a magnesium metal surface of one or more cradle attachment portions. In various embodiments, the various thermal plastic materials are suitable for the above-described implementation. In at least one embodiment, the thermal plastic material includes polycarbonate or equivalent. At 1308, a portion of a pod cover can be etched to provide for electrical contact to a touch-detection circuit. At 1310, one or more pod covers are selected and a sealant 1312 may be applied thereto. For example, an epoxy may be applied adjacent to one or more edges of a top pod cover, whereby the epoxy may contact a one or more surface of a cradle disposed within an interior region formed between the top pod cover and a bottom pod cover. Note that flow 1300 is not intended to be exhaustive in may be modified within the scope of the present disclosure.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A wearable pod comprising:
a first pod cover comprising micro-perforations in a metal substrate;
a cradle configured to house circuitry and to accept conductors extending external to the wearable pod;
a touch-sensitive detector disposed in the cradle and coupled to the first pod cover to detect a capacitance at a surface portion of the first pod cover in a range of capacitance values and to generate one or more signals indicating a value is detected in the range;
a conductive path between the first pod cover and the touch-sensitive detector;
a signal decoder configured to receive the one or more signals to decode a command; and
a second pod cover.

2. The wearable pod of claim 1, further comprising:
an interface including a display formed in the metal substrate at the surface portion of the first pod cover,
wherein the display includes arrangements of subsets of the micro-perforations in the metal substrate, at least one of which forms a pixelated symbol.

3. The wearable pod of claim 2, wherein the touch-sensitive detector is configured to detect the capacitance at the display.

4. The wearable pod of claim 1, wherein the signal decoder is further configured to decode an enable command to enable decoding of the one or more signals or a disable command to disable decoding of the one or more signals.

5. The wearable pod of claim 1, further comprising:
a context detector configured to generate a signal representative of a context of the wearable pod based on a type of activity,
wherein the signal decoder is configured to implement a first set of commands based on a pattern of capacitance values based on a first context, and is further configured to implement a second set of commands based on the pattern of capacitance values based on a second context

6. The wearable pod of claim 1, wherein the signal decoder is further configured to decode a mode command to transition the wearable pod to a mode of operation as a function of a capacitance pattern that forms the one or more signals.

7. The wearable pod of claim 6, further comprising:
a mode controller configured to determine a mode of operation based on the mode command, the mode of operation being one or more of an active mode, a sleep mode and a heart rate presentation mode.

8. The wearable pod of claim 7, further comprising:
a display controller configured to determine the mode of operation and to cause emission of light through a subset of the micro-perforations from light sources,
wherein the subset of the micro-perforations constitute a set of symbols indicative of the mode of operation.

9. The wearable pod of claim 1, further comprising:
a bioimpedance circuit disposed in the cradle and configured to couple to a first subset of conductors to receive electrical signals embodying physiological data.

10. The wearable pod of claim 1, further comprising:
a galvanic skin response circuit disposed in the cradle and configured to couple to a second subset of conductors to receive electrical signals indicative of a conductance value across a portion of tissue.

11. A method to operate a wearable pod comprising:
detecting a capacitance value at a top pod cover portion in a range of capacitance values;
determining a mode of operation based on the capacitance value;
receiving subsets of sensor data;
selecting a subset of the sensor data based on the mode of operation;
determining values of at least one physiological signal based on the subset of sensor data;
identifying a subset of light sources to emit light through an arrangement of micro-perforations constituting symbols indicative of the values of the physiological signal.

12. The method of claim 11, further comprising:
displaying the symbols via a metal substrate to the top pod cover portion; and
detecting another capacitance value at the top pod cover portion that includes a portion of the metal substrate.

13. The method of claim 11, further comprising:
determining a pattern of detected capacitance values; and
generating a command based on the pattern of detected capacitance values.

14. The method of claim 13, wherein determining the pattern of the detected capacitance values comprises:
detecting durations of the detected capacitance values; and
detecting quantities of the detected capacitance values as a function of time.

15. The method of claim 13, further comprising:
identifying a first pattern of the detected capacitance values associated with the command to disable implementation of a subset of subsequent detected capacitance values; and
disabling implementation of the subset of subsequent detected capacitance values.

16. The method of claim 13, further comprising:
identifying a second pattern of the detected capacitance values associated with the command to transition to another mode of operation; and
transitioning the wearable pod to the another mode of operation.

17. The method of claim 11, wherein selecting the subset of the sensor data comprises:
receiving bioimpedance signals indicative of a heart rate values as the physiological signal.

18. The method of claim 12, wherein identifying the subset of light sources comprises:
identifying a quantity of lights from which to emit light, the quantity of lights being proportional to the heart rate.

19. The method of claim 11, further comprising:
selecting another subset of the sensor data;
receiving accelerometer signals indicative of an activity; and
determining a value indicative of the activity.

20. The method of claim 19, wherein identifying the subset of light sources comprises:
identifying another quantity of lights from which to emit light, the quantity of lights being proportional to the value indicative of the activity.
